(19) United States
(12) Patent Application Publication
(10) Pub. No.: US 2024/0018030 A1
(43) Pub. Date: Jan. 18, 2024

(54) HOT FORMING OF CURVED MIRRORS WITHOUT THE NEED FOR A MANDREL

(71) Applicant: The Regents of the University of California, Oakland, CA (US)

(72) Inventors: Philip Hinz, Santa Cruz, CA (US); Matthew Radovan, Santa Cruz, CA (US)

(73) Assignee: The Regents of the University of California, Oakland, CA (US)

(21) Appl. No.: 18/352,403

(22) Filed: Jul. 14, 2023

Related U.S. Application Data
(60) Provisional application No. 63/429,889, filed on Dec. 2, 2022.
(60) Provisional application No. 63/389,714, filed on Jul. 15, 2022.

(51) Int. Cl. C03B 23/025; G02B 5/10; G02B 5/08; G02B 23/02

(52) U.S. Cl. CPC C03B 23/0252; G02B 5/10; G02B 5/0808; G02B 23/02

(57) ABSTRACT

A method and apparatus for fabrication of mirror facesheets that uses a hot thermal forming process, or slumping. Rather than relying on an accurate negative form to slump the glass into, the glass is allowed to slump freely within a support ring that is outside the final required optical diameter of the shell. Such an approach allows for creation of shells over a variety of radii of curvature, simply by changing details of the heating process. However, to create an approximately parabolic shape, an additional force is required. The expected deformation can be modeled to show that a top weight with a given force just outside the optical diameter creates close to the desired shape. Experimental verification has been demonstrated for shells 120 mm in diameter. The forming fixtures and processes can be optimized and scaled to larger facesheets needed for upcoming ASM's.

### CROSS REFERENCE TO RELATED APPLICATIONS

This application claims the benefit under 35 U.S.C. Section 119(e) of the following co-pending and commonly-assigned applications:
U.S. Provisional Application Ser. No. 63/389,714, filed on Jul. 15, 2022, by Philip Hinz and Matthew Radovan, entitled “HOT FORMING OF CURVED MIRRORS WITHOUT THE NEED FOR A MANDREL,” Attorney's Docket Number 284.0015USP1; and U.S. Provisional Application Ser. No. 63/429,889, filed on Dec. 2, 2022, by
Philip Hinz and Matthew Radovan, entitled “HOT FORMING OF CURVED MIRRORS WITHOUT THE NEED FOR A MANDREL,” Attorney's Docket Number 284.0015USP2;
   both of which applications are incorporated by reference herein.

### BACKGROUND OF THE INVENTION

### 1. Field of the Invention

The present invention relates to mirrors and methods of making the same and generating curved deformable facesheets via free form slumping.

### 2. Description of the Related Art

Large format active or deformable mirrors can enable optical applications that are difficult to achieve with more conventional sized (10-100 mm) deformable mirrors. In particular adaptive secondary mirrors (ASM's) can be built into a conventional telescope to provide wavefront correction without any impact on throughput, background or noise, or associated limitations on the field of view of more conventional deformable mirrors.

Current generation ASM's have been implemented at several telescopes, including the MMT, LBT, ¹Magellan, and VLT using Lorentz force (commonly called voice-coil) actuators and thin glass shells to replace the standard secondaries (see ² for an overview). These actuators apply force via a current carrying wire coil acting on a permanent magnet attached to a thin curved facesheet. The advantage of this design is the high stroke and linearity achieved. However, the low power efficiency of the actuators drives designs that require active cooling, co-located, high speed position control and thin (and consequently fragile) facesheets. These are all issues for which technical solutions exist, but they contribute to the complexity and maintainability of the assembly.

The Netherlands Organization for Applied Research (Toegepast Natuurwetenschappelijk Onderzoek or TNO) has developed a technology with efficiencies approximately 80 times that of similarly sized voice-coil actuators. ³The actuators utilize the efficiency gains of enclosing the magnetic field path that drives the actuator in a ferromagnetic material, thus reducing the current needed to apply a particular force. This larger force allows for building in an internal stiffness to each actuator and rigid connections to the facesheet. The resulting assembly has very high structural resonant frequencies, compared to voice coil designs, allowing a simple control approach. Further, the power required to correct turbulent wavefronts can be dramatically lower, allowing for simpler, passive cooling approaches to the system. Finally, the additional efficiency can be traded against the facesheet.

In addition to more powerful actuators, facesheet fabrication is a technical challenge for ASM's. Current state-of-the-art fabrication uses conventional glass polishing approaches to grind and polish an aspheric surface into a thick glass blank. The optic is then mated via pitch to a sacrificial additional glass blank so that it can be machined to the required thickness, typically around 2 mm. This process has been successfully used first at SOML and then REOSC for current ASM's. However, the process is both costly and risky, motivating the exploration of an alternative fabrication method. The present invention satisfies this need.

### SUMMARY OF THE INVENTION

Embodiments of the present invention utilize a hot forming technique to fabricate large, curved mirrors suitable for imaging and energy concentration optical systems. The technique utilizes the deflection of flat sheets with the application of pressure at temperatures near the transformation of glass. In some examples, the approach is iterative (allowing for correction of slight fabrication variations) and makes use of support rings to create the desired mirror shapes.

Illustrative embodiments of the present invention include, but are not limited to, the following.

1. An apparatus for forming a sheet of glass, comprising:
a support structure comprising a first opening bounded by a first mounting frame dimensioned for supporting the glass sheet in a first region on an underside of the glass sheet, and
a load structure comprising a second opening bounded by a second mounting frame dimensioned for loading a glass sheet with a load distribution in a second region on a top surface of the glass sheet; so that:
slumping of the glass sheet at a slumping temperature forms a mirrored surface on the top surface when the first region and second region are the only contact regions with the glass sheet,
the mirrored surface is formed during exposure to an atmosphere through the second opening, and
the mirrored surface comprises an aperture bounded by the second region and the first region is outside the second region.

2. The apparatus of example 1, wherein the first mounting frame comprises a first ring or annulus and the second mounting frame comprises a second ring or annulus having a diameter smaller than the first ring or annulus.

3. The apparatus of example 1 or 2, wherein the first ring and the second ring are mounted on the glass sheet concentrically.

4. The apparatus of any of the examples 1-3, further comprising:
a kiln comprising a chamber; wherein the kiln is configured to heat the glass sheet, supported between the load structure and the support structure, to the slumping temperature.

5. The apparatus of example 4, further comprising a computer or controller controlling the slumping temperature so as to form the mirrored surface.

6. A mirror, comprising:
a glass sheet having a mirrored surface, the mirrored surface comprising a curvature and finish or surface roughness formed by slumping from a restraint in a first region while under load in a second region, when the restraint and the load are the only contacts with the glass sheet other than an atmosphere.

7. The mirror of example 1, wherein the mirrored surface comprises an aperture bounded by positioning of the load along a perimeter of the aperture.

8. The mirror of example 6, wherein the first region comprises a first annular region having a first radius and the second region comprises a second annular region having a second radius smaller than the first radius.

9. The mirror of example 8, wherein the mirror has a radius bounded by the first annular region.

10. The mirror of any of the examples 6-9, wherein the curvature and finish are defined by elastic deformation of the glass sheet as a result of the slumping.

11. The mirror of any of the examples, wherein the curvature and finish are approximated by Roarke' formulas.

12. The mirror of any of the examples, wherein:
the mirror comprises a telescope mirror having the finish (or specular reflectance) useful for an astronomical observation, or
the mirror comprises a solar concentrator having the finish (or specular reflectance) suitable for concentrating solar electromagnetic radiation onto an energy converting device (e.g., solar cell or photovoltaic device) or energy storage device (e.g., salt, water, glass or other material that heats up in response to the concentrated solar radiation), or
the mirror is used in an imaging system and the finish (or specular reflectance) is suitable for forming an image.

13. The mirror of any of the examples 6-12, wherein the curvature comprises a parabola.

14. The mirror of any of the examples 6-13, wherein the mirrored surface has comprises the aperture having a diameter in a range of 100 millimeters to 1400 mm.

15. A method for forming a sheet of glass into a mirror, comprising:
(a) supporting a flat or planar glass sheet with a support structure only in a first region on an underside of the glass sheet;
(b) loading the glass sheet with a load distribution using a load structure and only in a second region on a top side of the glass sheet;
(c) heating the glass sheet, supported between the load structure and the support structure, to a slumping temperature so as to form a curved mirrored surface of the glass sheet when the first region and second region are the only contact regions with the glass sheet other than with an atmosphere through an opening in the load structure.

16. The method of example 13, further comprising:
modeling a desired curvature of the curved mirror surface as a function of the load distribution and the slumping temperature, to obtain a modeled load distribution and a modeled slumping temperature; wherein the loading comprises loading with the modeled load distribution and the slumping temperature comprises the modeled slumping temperature.

17. The method of example 15 or 16, wherein the method comprises an iterative process, comprising:
measuring at least one of a surface roughness or a curvature of the curved mirrored surface;
comparing the surface roughness with a target surface roughness to obtain a roughness error and/or comparing the curvature with a target curvature to obtain a curvature error;
repeating steps (a)-(c) using the load distribution comprising a modified load distribution determined using the roughness error and the slumping temperature comprising a modified slumping temperature determined using the curvature error.

18. The method of any of the examples 15-17, wherein the mirror comprises:
a telescope mirror having the finish (or specular reflectance) useful for an astronomical observation, or
the mirror comprises a solar concentrator having the finish (or specular reflectance) suitable for concentrating solar electromagnetic radiation onto an energy converting device (e.g., solar cell or photovoltaic device) or energy storage device (e.g., salt, water, glass or other material that heats up in response to the concentrated solar radiation), or
is used in an imaging system for forming an image.

19. The method of any of the examples 15-18, wherein the mirrored surface comprises an aperture bounded by the second region along a perimeter of the aperture, the method further comprising cutting the glass sheet along an inside of the second region to form the mirror comprising the aperture.

20. The method of any of the examples 15-19, wherein the support structure comprises a first ring contacting the glass sheet in the first region comprising a first annular region having a first radius and the load structure comprises a second ring contacting the glass sheet in the second region comprising a second annular region having a second radius smaller than the first radius.

21. The method or apparatus of any of the examples 1-5 or 15-20, wherein the mirror comprises a telescope mirror having the finish (or specular reflectance) useful for an astronomical observation.

22. The method or apparatus of any of the examples 1-5 or 15-20, wherein the curvature comprises a parabola.

23. The mirror of any of the examples 6-13, wherein the mirrored surface has comprises the aperture having a diameter in a range of 100 millimeters to 1400 mm.

24. The method, apparatus, or mirror of any of the examples, wherein the slumping temperature is a transformation temperature that softens the glass sheet so as to allow the glass in the glass sheet to flow under the force of gravity and the pressure applied by the loading.

25. The method, apparatus, or mirror of any of the examples, wherein the slumping temperature is in a range of 500° C.-1100° C. and the load distribution comprises a mass in a range of 1-15 kg distributed along a perimeter of the mirror's aperture.

### BRIEF DESCRIPTION OF THE DRAWINGS

Referring now to the drawings in which like reference numbers represent corresponding parts throughout:

FIG. 1: Conventional concept for hot forming or slumping of a glass shell. A mold is first fabricated that is the negative of the desired shape. An initially flat glass sheet is heated to a temperature where the facesheet takes on the shape of the mold.

FIG. 2: Model of a ring supported plate under elastic deformation. A shell with a 900 mm radius of curvature can expect to have 180 microns of P-V spherical aberration, compared to a perfect sphere.

FIG. 3: Experimental setup showing an initial test of freeform slumping using self-weight. The resulting measured shape reached the desired 900 mm radius of curvature, with about 180 μm of P-V spherical aberration, consistent with the model.

FIG. 4: Method and Apparatus for hot forming or slumping of a glass shell without the need for a mold. A ring base and ring top weight is needed to create the correct shape. The glass shell needs to be cut down to only the portion smaller than the top weight.

FIG. 5: Analytical Model of the slumping of a 75 mm radius shell using a 62 mm radius top ring with different weights. This model suggest about 5 kg of weight is needed to remove the spherical aberration.

FIG. 6: Numerical model of the slumping of a 75 mm radius shell using a 62 mm radius top ring and a 0.5 mm decenter. The resulting aberration is coma with a 30 μm amplitude.

FIG. 7: Setup for slumping experiments. The left image shows the glass sheet on the base held against some end stops with leaf spring flexures around the edge. The right image shows the same setup after adding the top weight, including centration tabs extending down to the base.

FIGS. 8A-8C: Fits to low order residuals for successive slumps of the L2 shell. The shell was rotated by 180 degrees between slumps A and B to reduce coma, wherein FIGS. 8B and 8C are zoomed in views of sections I and II, respectively in FIG. 8A.

FIGS. 9A-9D: Fits to low order residuals for successive slumps of the L5 shell. A 1.5 kg weight was used for this series resulting in remaining SA, wherein FIGS. 9B-9D are zoomed in views of sections I, II, and III, respectively, in FIG. 9A.

FIGS. 10A-10J: Fits to low order residuals for successive slumps of the L7 shell. Slumps A-C were used to create approximately the right radius, rotating the top weight to reduce coma. Slump D was done without a top weight to reduce SA. Slump G was setup to remove astigmatism, but too hot a temperature was selected, resulting in overshoot. The process still showed the correct process for removing astigmatism in future shells and wherein FIGS. 10B-10J are zoomed in views of sections I-IX, respectively, in FIG. 10A.

FIG. 11: Residual aberrations for L2, L5, and L7 before and after removing the non-optical portion of the shells.

FIG. 12. Flowchart illustrating a method of making a mirror.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

Hot Forming Approaches

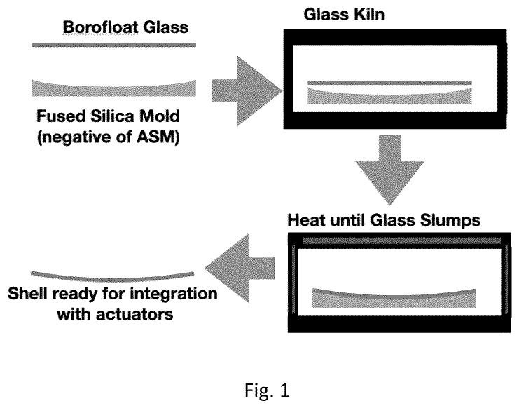

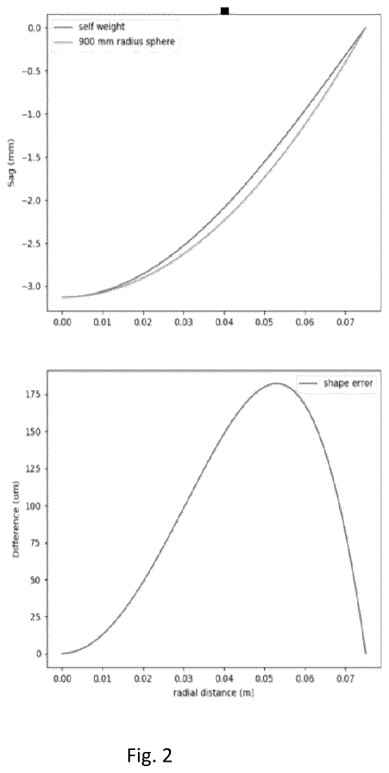

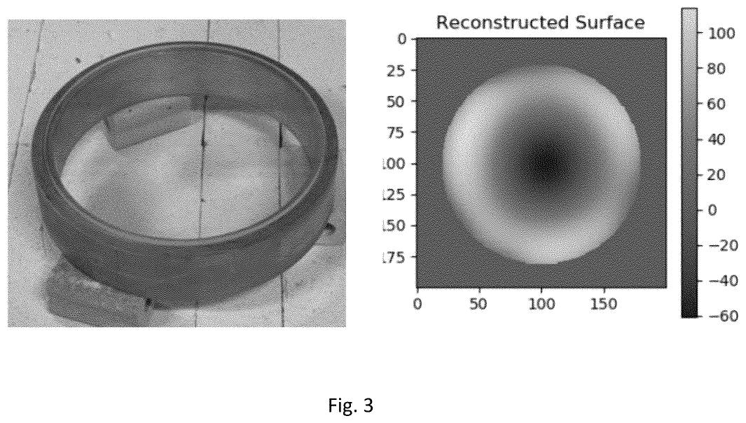

Hot forming or slumping of glass shells is an alternative technique for manufacturing curved facesheets that has been explored by a number of groups, for X-ray optics as well as adaptive optics. The technique typically involves the fabrication of a negative form that is created to allow the facesheet to slump into by the combination of heat and either self-weight of the shell or vacuum-assisted deformation as shown in FIG. 1.

Experiments have shown that a reasonably good approximation of the desired surface with a longer radius of curvature was created even if the shell was not heated to a high enough temperature. Essentially, the form acted as a ring support structure, with the shell deforming into a prescribed shape that can be accurately predicted using plate deformation theory. By adjusting temperatures, shells that deform freely to a given radius could be manufactured.

These experiments led the inventors to a new process named “Free Form Slumping”. The goal of carrying out these efforts is to create a process that requires a minimum of precision in the support fixture for the shell, and is tolerant to process variations.

Free Form Slumping

A thin plate that deforms under its own weight takes on a shape that departs from a plane parallel geometry. If we treat the plate as structurally thin, the surface can be calculated as

$$sag ( r ) = \frac{q}{16 D} ( \frac{3 + v}{1 + v} {a}^{2} {r}^{2} - {r}^{4} / 4 ) \qquad ( 1 )$$

where q is the weight of the sheet, D is the modulus, v is Poisson ratio of the material and a is the radius of the sheet. The r⁴ term is undesirable. In optical terms, this imparts a spherical aberration to the wavefront.

Slumping under self-weight is equivalent to applying a uniform load across the shell. However, there must exist a load distribution that eliminates the r⁴ term, leaving only the desirable r² deflection. This can be accomplished with a line load near the outer edge of the shell, which can be implemented by placing a weight on the shell using a ring structure. Such an approach creates an area within the top ring that is nearly the ideal shape.

To create the final facesheet one needs to start with a slightly larger initial facesheet. The material between the top ring and the outer support structure then needs to be cut off to create the final product.

The above technique has several advantages over previous hot forming processes. Primarily, this approach eliminates the need for a precision machined negative form for the shell. Both the support structure and the top weight can be mechanically simple to machine rings. This approach is also easy to adapt for different optical prescriptions. Different radii of curvature can be created just by tuning the peak temperature and top weight.

In addition, any errors introduced by this process are necessarily low spatial frequency, since no solid contact is made between the optical portion of the facesheet and the forming fixture.

Example Fabrication Setup

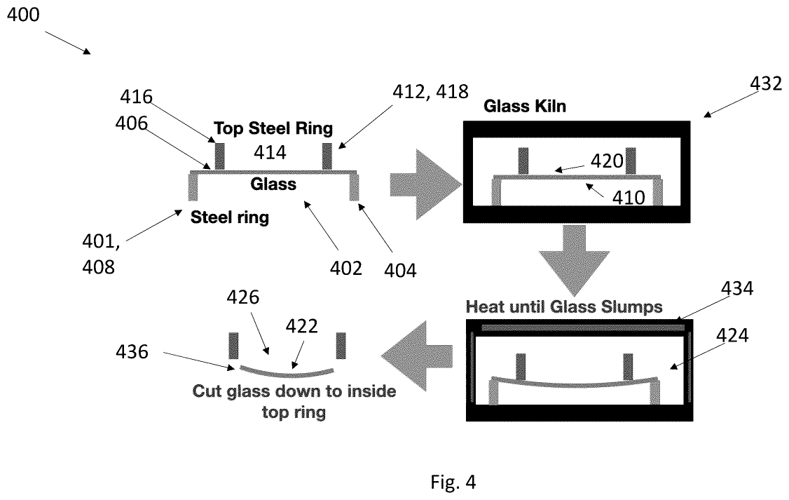

FIG. 4 illustrates an apparatus 400 for forming a sheet of glass comprising:
(a) a support structure 401 comprising a first opening 402 bounded by a first mounting frame/mount 404 dimensioned for supporting the glass sheet 406 in a first region 408 on an underside 410 of the glass sheet 406; and
(b) a load structure 412 comprising a second opening 414 bounded by a second mounting frame/mount 416 dimensioned for loading the glass sheet 406 with a load distribution in a second region 418 on a top surface 420 of the glass sheet, so that:
(c) slumping of the glass sheet at a slumping temperature forms a mirrored surface 422 on the top surface when the first region and second region are the only contact regions with the glass sheet, the mirrored surface is formed during exposure to an atmosphere 424 through the second opening, and the mirrored surface comprises an aperture 426 bounded by the second region.

In one or more examples, the first mounting frame 404 comprises a first ring or annulus 428 and the second mounting frame 416 comprises a second ring or annulus 430 having a diameter smaller than the first ring or annulus. The first ring and the second ring can be concentrically mounted on the glass sheet. For the data presented herein, the initially flat facesheet 406 is placed on a steel ring 404 and a smaller steel ring 416 is placed on top of it. This top ring is sized to be slightly larger than the final optical diameter of the shell. The weight of the top ring 416 is chosen to be suitable for bending out the spherical aberration that would otherwise be induced by slumping via self-weight of the shell.

FIG. 4 illustrates the apparatus further comprises a kiln 432 comprising a chamber; wherein the kiln is configured to heat the glass sheet, supported between the load structure and the support structure, to the slumping temperature. A computer or controller can be coupled to the kiln for controlling the slumping temperature so as to form the mirrored surface. Temperature sensors (for monitoring the temperature) and a heater 434 (for heating glass sheet) can be appropriately positioned in the chamber and thermally coupled to the glass sheet).

For the data presented herein, the whole apparatus assembly 400 is placed into a glass kiln 432 capable of heating glass to near its transformation temperature. Compared to self-weight slumping, a slightly lower soak temperature is chosen, to account for the additional top weight.

Once the shell 436 is removed from the kiln it is then cut to its final size, removing all the glass that was in contact with either the bottom support ring or the top weighted ring.

Example Modeling of the Deformation.

The modeling of the deformation is approximated using a purely elastic plate calculation, as described above. These calculations correspond well to the viscous deformation that is actually occurring by heating the glass. More or less “elastic” deformation is achieved by either adding more weight to the top of the assembly, heating the glass to a hotter temperature, or letting the glass “soak” at peak temperature for a longer period.

Use of elastic calculations is motivated by the use of the correspondence principle between elastic and viscoelastic materials. The correspondence principle can be used to carry out a purely elastic calculation of deformation, corresponding to viscous creep of the same form for a given length of time. This allows us to predict the final shape of the shell under particular loading cases.

Analytical solutions for elastic deformations of circular plates exist for a variety of boundary conditions and top loads. ⁴These formulas have been used to predict slumping for various setups. While uniform loading of circular plates creates deformations with high order radial error, the inventors discovered that edge-loading of a circular plate results in parabolic surfaces, very close to the desired shape of typical hyperbolic secondaries that are part of typical optical telescope designs. Further, by tuning the amount of edge-loading compared to uniform loading, it is possible to fine tune the final desired shape to surfaces with a range of conic constants.

From Roark's formulas, ⁴the deflection, y, of a simply supported line load inside the applied load is:

$$y = {y}_{c} + \frac{{M}_{c} {r}^{2}}{2 D ( 1 + v )} \qquad ( 2 )$$

where D and v are the elastic modulus and Poisson's ratio, and M_{c} and y_{c} corresponds to the maximum deflection of the plate given by

$${y}_{c} = - \frac{{wa}^{3}}{2 D} * [ \frac{{L}_{9}}{1 + v} - 2 {L}_{3} ] \qquad ( 3 )$$

$${M}_{c} = {waL}_{9} \qquad ( 4 )$$

where r₀ is the radius of the line load, amd the constants, L₃ and L₉ are given by:

$${L}_{3} = \frac{{r}_{0}}{a} \frac{1 + v}{2} ln ( \frac{a}{{r}_{0}} ) + \frac{1 - v}{4} ( 1 - {( \frac{{r}_{0}}{a} )}^{2} ) \qquad ( 5 )$$

$${L}_{9} = \frac{{r}_{0}}{4 a} ( ( {( \frac{{r}_{0}}{a} )}^{2} + 1 ) ln ( \frac{a}{{r}_{0}} ) + {( \frac{{r}_{0}}{a} )}^{2} - 1 ) \qquad ( 6 )$$

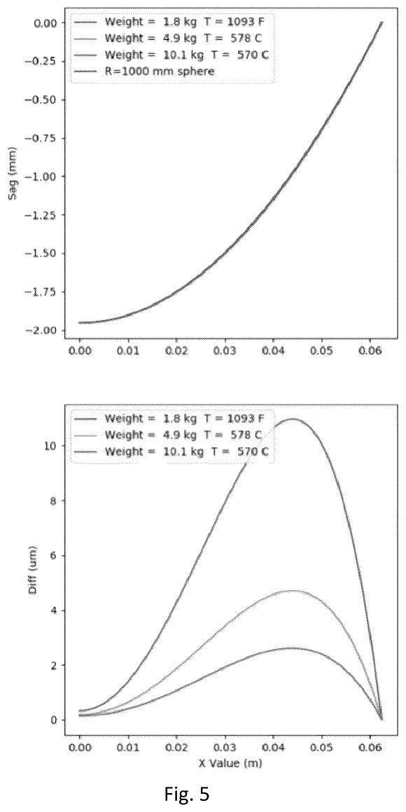

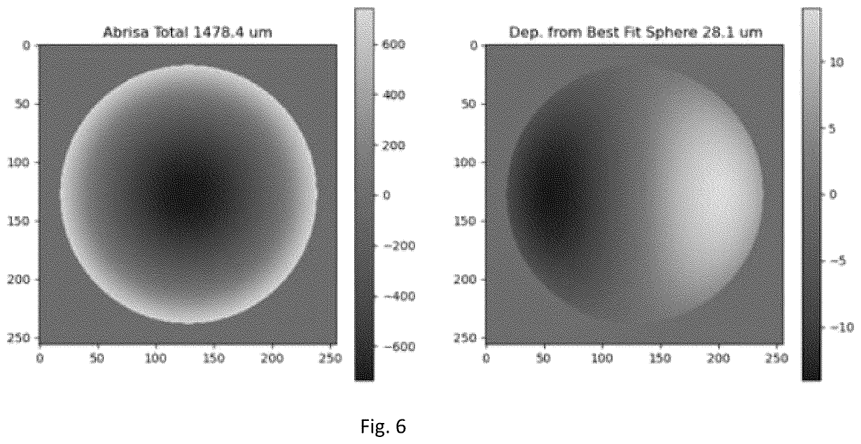

By combining equation 1 and 3 with an appropriately chosen modulus to obtain a desired amount of sag, the amount of residual spherical aberrations for different weights can be predicted. FIG. 5 shows the resulting predicted shapes.

Example Numerical Calculations

To predict effects from more realistic setups including effects of centration, ring height variation, and other imperfections, a finite element model is preferred. We have used the FENICS python package to carry out these same elastic deformation calculations, but now with the ability to put in arbitrary departures from the ideal simple circular plate and weight.

An initial result of this analysis is that the centration of the top weight is critical for keeping coma to a minimum. However, the required centration accuracy over the diameter of the shell is a constant. It appears that keeping the centration to 0.2% of the optical diameter will be important for keeping coma below the required level. Alternatively, moving the centration ring around by about 0.2% from one slump iteration to the next should be sufficient to keep it under control.

Example Characterization Experiments

To test the concept described above, a base fixture and top weighted ring were manufactured and configured to form 150 mm diameter, 3.3 mm thick flat polished borofloat glass sheets into curved shells. Since the steel expands more than the glass, thin flexures around the edge were used to keep the shell centered as the device is heated.

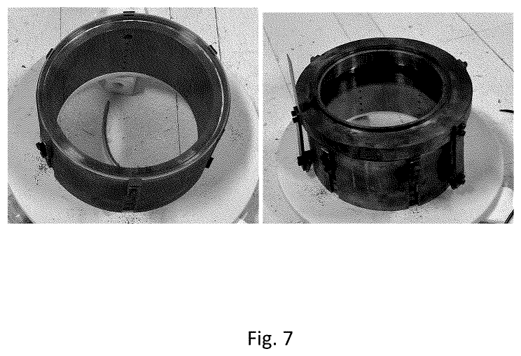

Similarly, the top weight was registered to the base using vertical tabs so that it remained centered. FIG. 7 shows a picture of the assembly loaded into the kiln. The top weighted ring is 125 mm in diameter. After cutting, the shells are 120 mm in diameter.

In one example, the setup can be used to create a shell that has a radius of R=1219.2 mm (48 inches). Slumping to this radius allows an easy comparison for surface variations on the convex surface by using an available concave R=48 in. optic. Using a mercury lamp, the interference between these surfaces can be viewed.

For in-process measurements, a phase deflectometry setup was used, wherein a camera creates images of a LCD screen, as viewed off the reflection from the concave surface of the slumped shell. Horizontal sine waves are displayed on the screen with ¼ wave phase shifts to measure the vertical slopes over the mirror, followed by vertical sinewaves to measure the horizontal slopes. The pixel size on the mirror is about 0.16 mm, although we bin by a factor of 10 for the results presented here. By surveying the geometry of the screen, camera, and optic, the slopes across the shell can be calculated, and the results can be integrated to estimate the wavefront.

As a test, the concave comparison optic (a commercial polished sphere from Edmund Optics) was measured. The resulting residuals have peak-to-valley variations that are about 0.3-1 μm from one setup to the next. Thus, the present disclosure provides a convenient setup to take quick measurements, although more refined measurements of completed shells can be performed as needed.

Using this approach, the correct weight (for the setup to minimize spherical aberration) was determined to be about 2.0 kg. Typical slumps could achieve the correct radius to within 10% accuracy after fine-tuning the peak temperature of the kiln. However, low orders residuals of 30-50 μP-V typically remained. These were often coma or astigmatism. However, careful remachining of the rings and fine-tuning the centering setup can be used to reduce these aberrations.

Example Iterative Approach

The experiments showed that a key improvement was to carry out successive slumps on a shell after testing it. By slumping and then testing, changes in the fixture with each cycle could be made to reverse aberrations induced by the previous cycle. For example, induced spherical aberration could be countered by decreasing the weight for the next cycle. Astigmatism could be corrected by rotating the shell in the fixture by 90 degrees. Coma could be corrected by rotating the shell by 180 degrees.

Using this approach, 15-20 μmP-V errors can be routinely achieved. More importantly, the radius can be tuned to be the correct value with a precision of under 1%. Further experimentation and refinement should be able to achieve the 5 μm requirement for integrating these shells with electromagnetic actuators.

In addition to iteratively correcting aberrations using multiple slumps, fine tuning slumps can be used to intentionally introduce aberrations into a shell. For example, by placing the shell on a two point support and heating to a lower temperature, astigmatism can be removed (or intentionally increased) on a shell without changing its radius. Coma can be introduced by offsetting the top weight in the direction of the desired coma.

This approach is an important step forward for achieving the results of a particular design. While slightly slower, it can dramatically improve the achievable precision.

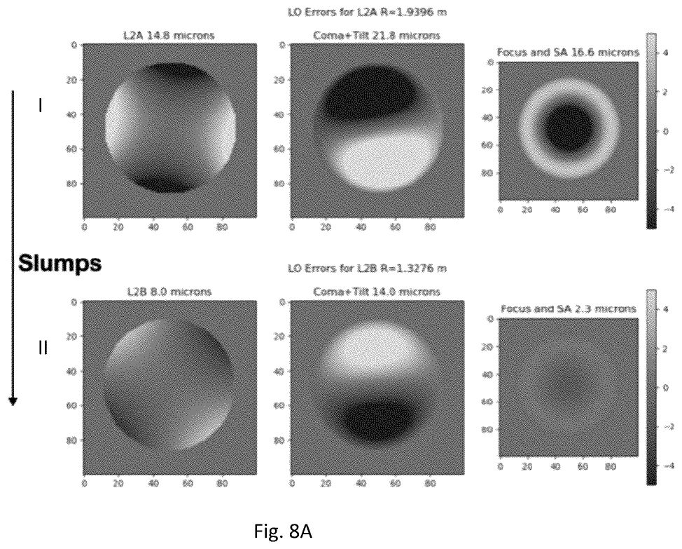

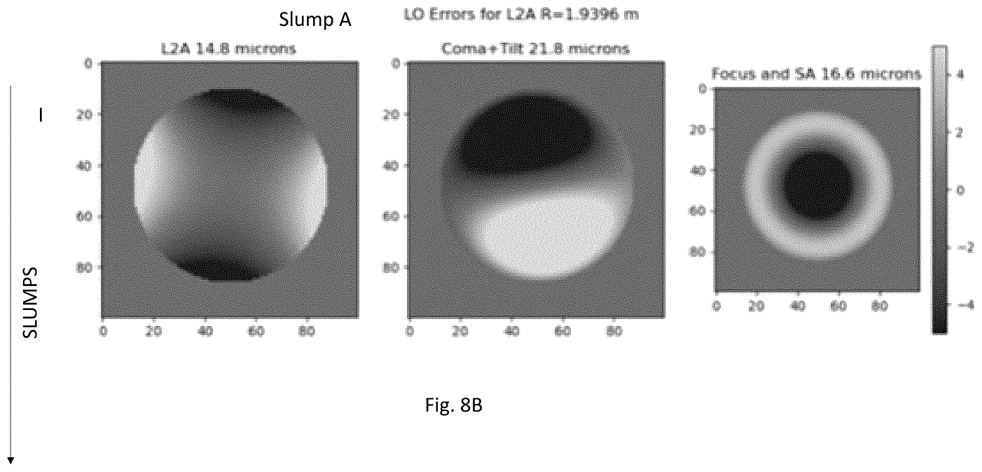

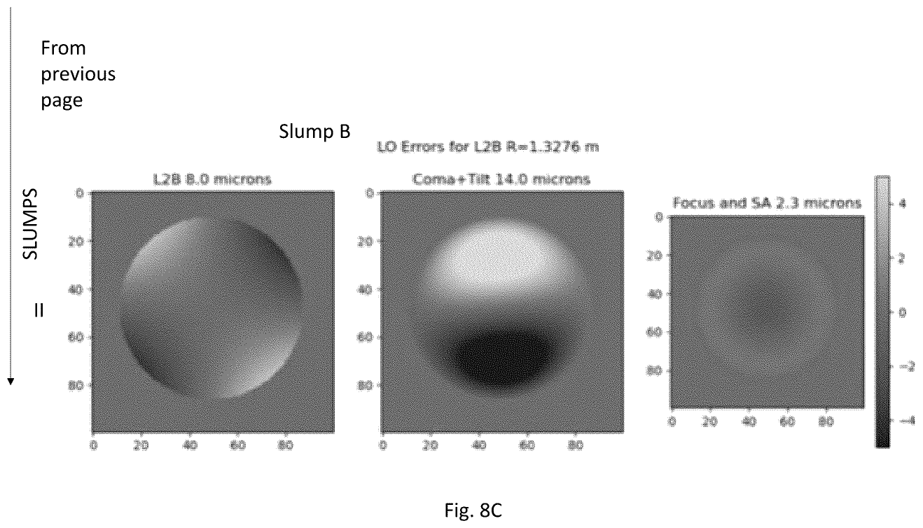

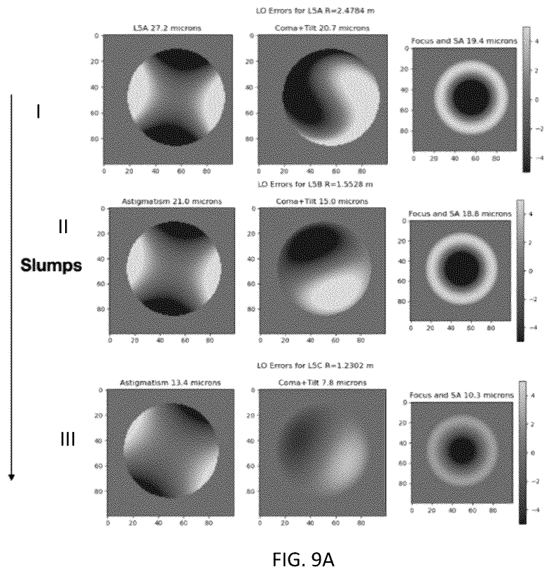

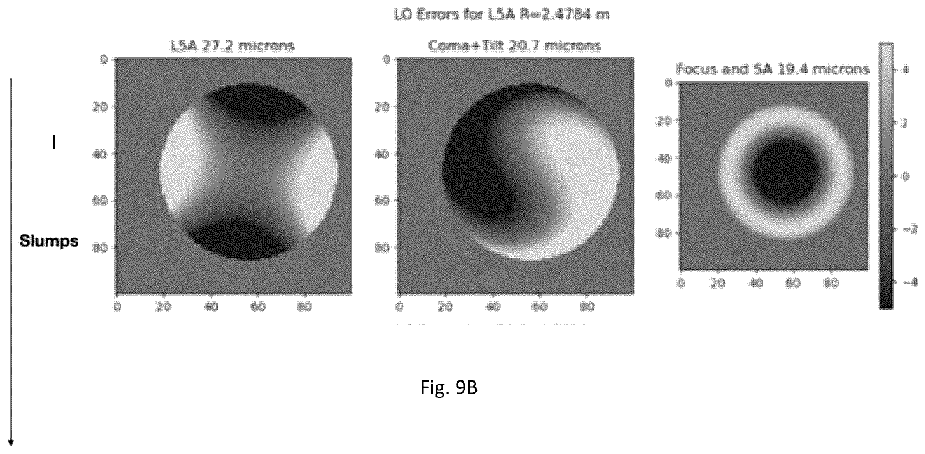

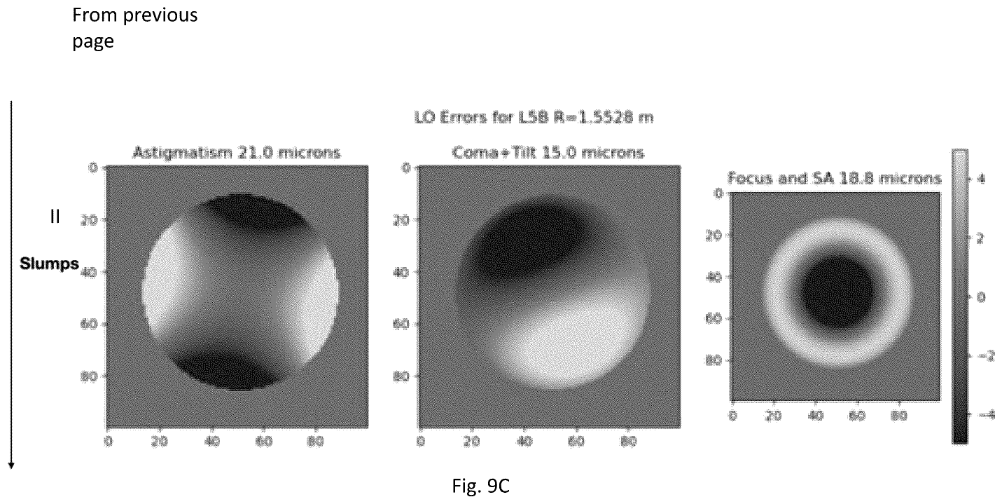

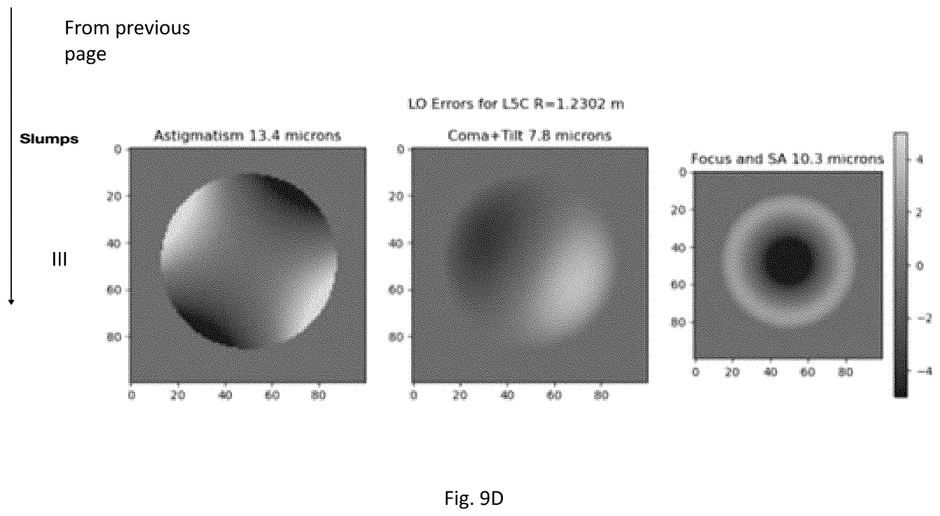

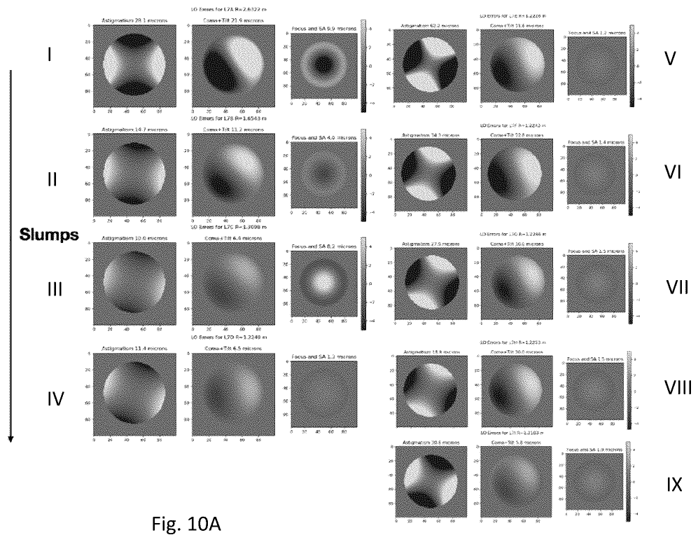

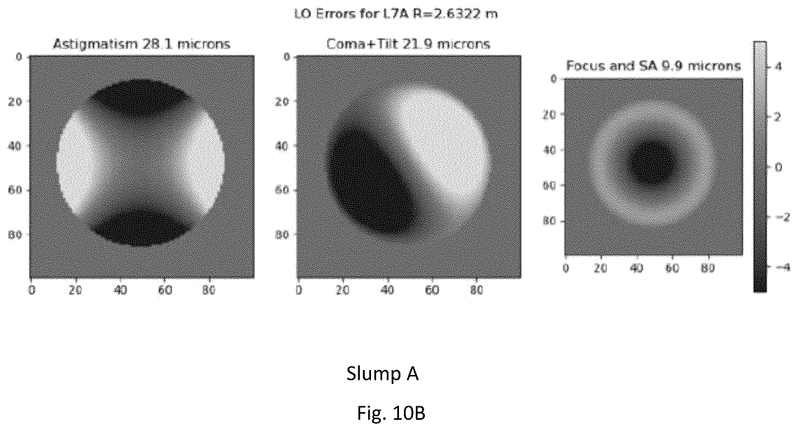

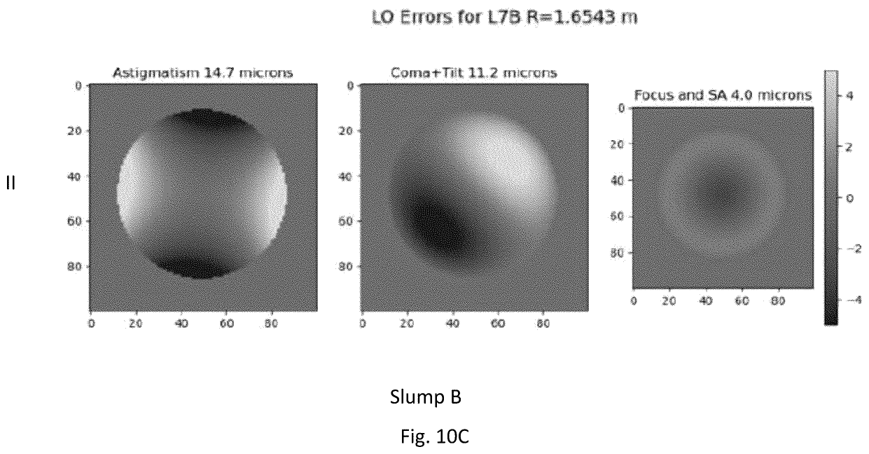

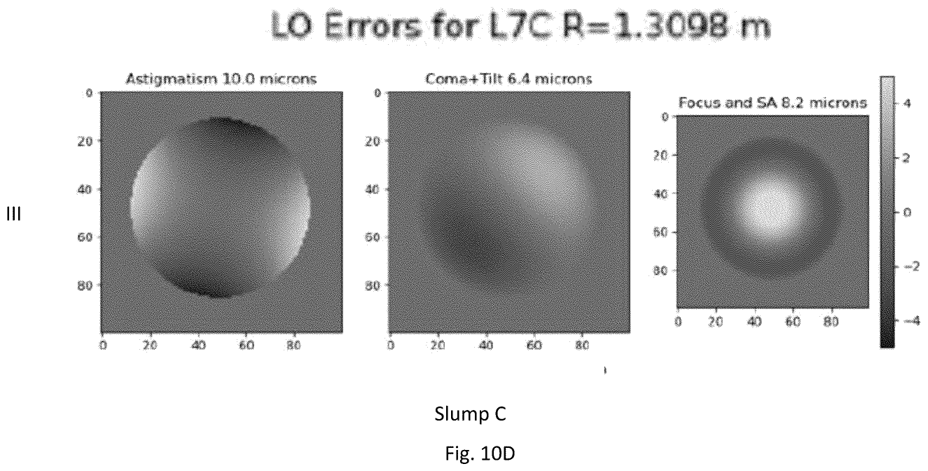

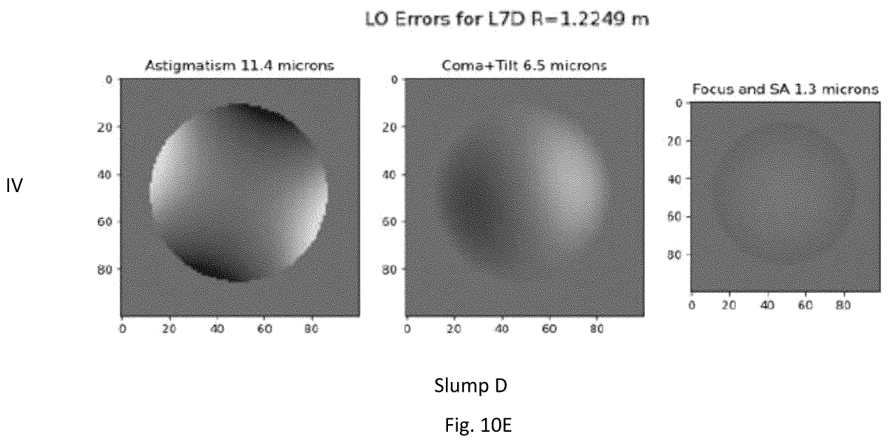

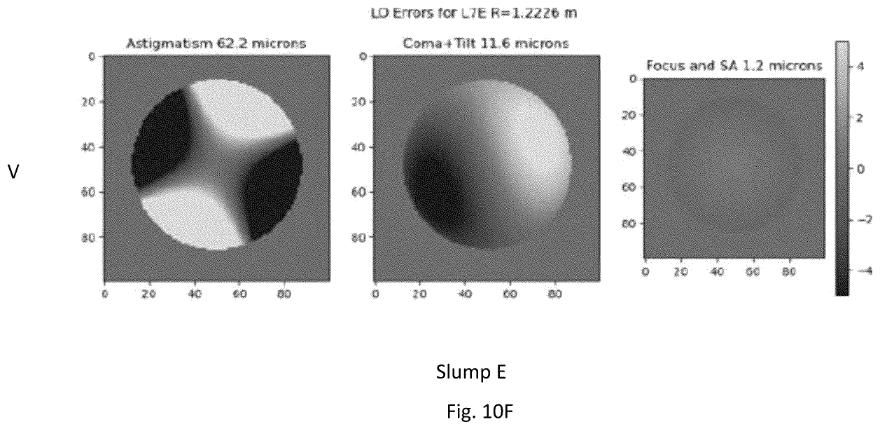

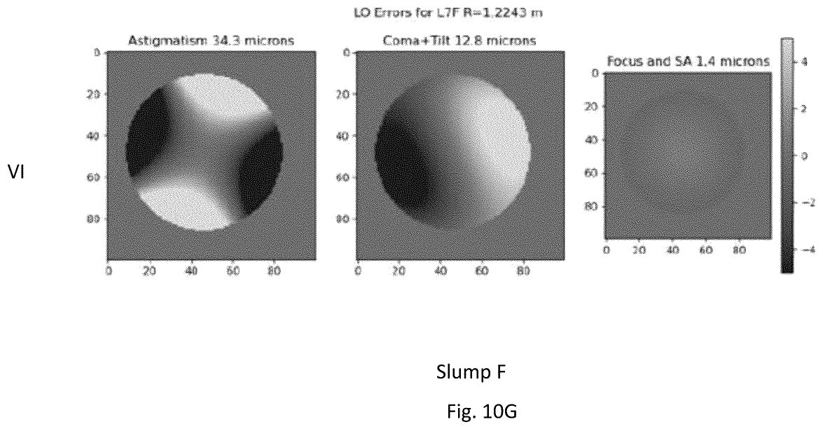

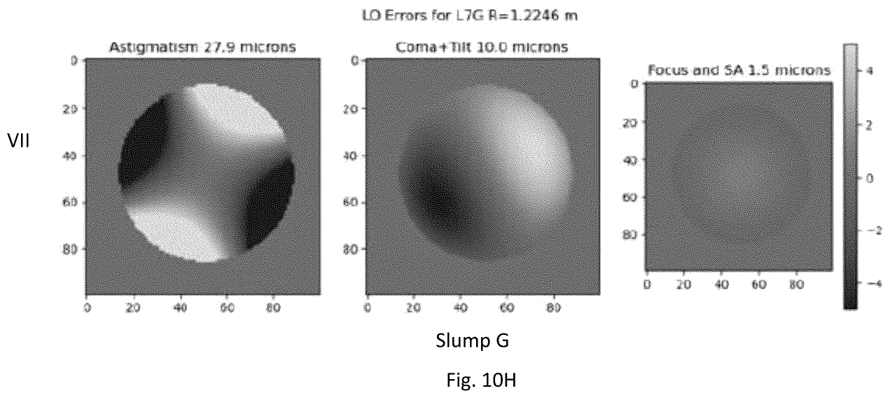

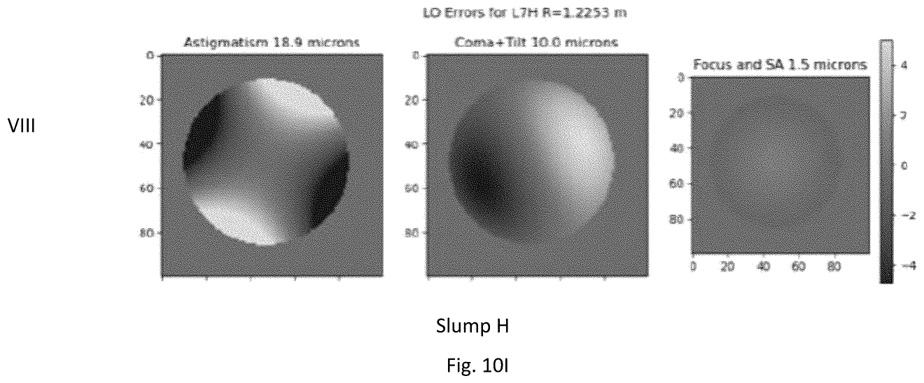

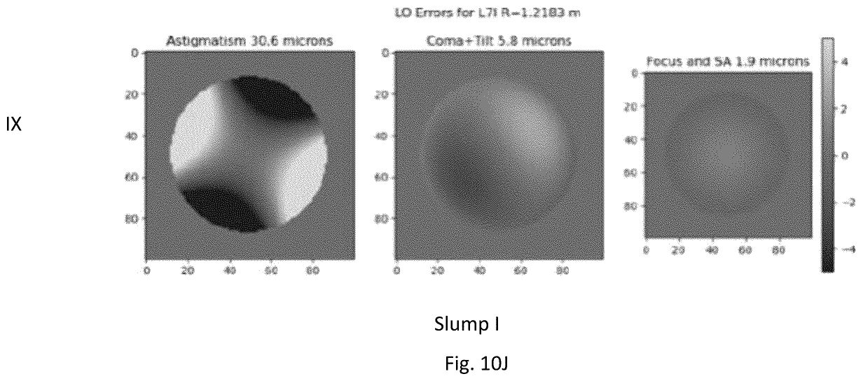

FIGS. 8,9, and 10 show the low order fitted residuals after each successive slumping cycle for three selected shells, L2, L5, and L7, illustrating the currently achievable performance. Each slumping cycle is denoted with a letter suffix. For example, the second slumping cycle of shell L2 is L2B, seen in the lower row of FIG. 8.

Removing Outer Region

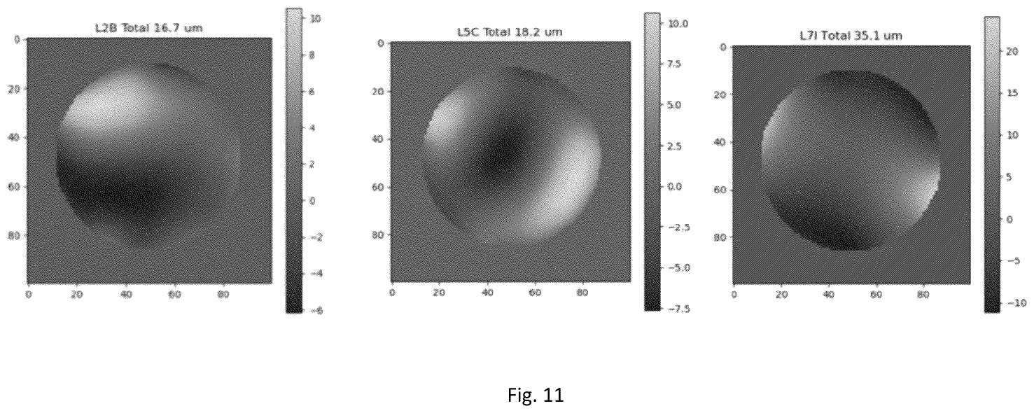

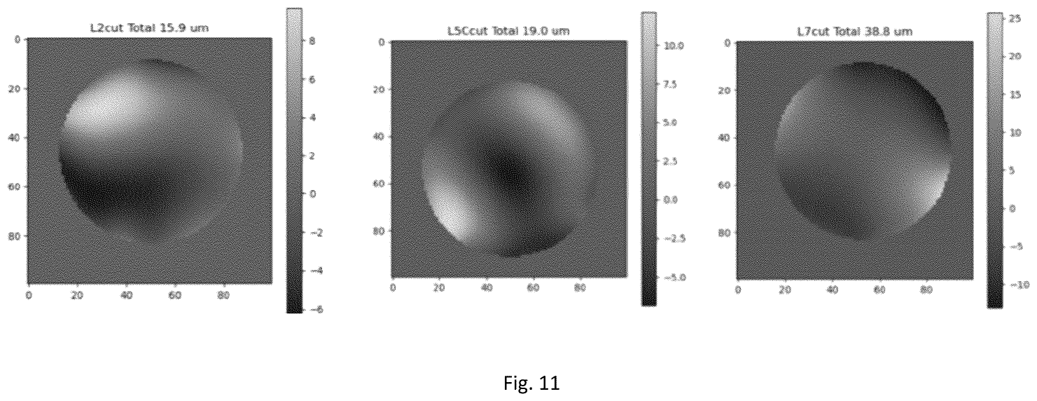

Once the shell has the desired properties, the outer edge can be removed to create the final optic. Tests carrying out this step both using water jet cutting and more standard score and snapping approaches have been performed to create the final optic. The amount of change in the surface shape is below the level easily measured with a deflectometry setup, as shown in FIG. 11.

Example Surface Micro Roughness

Shells were measured using a Veeco interferometer on the 15 mm scale, to identify any changes in micro-roughness. Since the optical portion of the shell makes no contact with the fixture during this process, additional high frequency residuals are not expected to be added. These measurements confirm that the before and after surface roughness is similar for several articles.

Possible Modifications, Variations and Applications

The technique and apparatus can be used for a variety of size optics. Another example includes using a similar setup for 400 mm diameter sheets, 3.3. mm thick, allowing fabrication of shells that are up to 300 mm in diameter, after removing the outer annulus.

Adaptive Secondary Mirrors (ASM's) provide telescope-integrated adaptive optics (AO) correction, potentially broadening the use of AO on the facility. Unlike post-focal plane AO systems, ASM's require large, curved, aspheric membranes to replicate the standard telescope secondary mirror that it replaces. Electromagnetic actuator technology has been developed to implement ASM's, but the devices require 200-1500 mm diameter curved facesheets. The present invention can be used to fabricate such ASMs.

Another possible application is as a replacement for the solid secondary in NASA's Infrared Telescope Facility (IRTF), wherein the secondary has a 243.8 mm diameter and a radius of 1311.5 mm. Deployment of an ASM on the IRTF could provide much improved image quality with a minimally invasive changes to the instrumentation. Such a shape is similar enough that the experiments described herein should be a good indication of the precision reachable for this mirror.

Other possible secondaries include the Nickel Telescope (D=318 mm, R=4869 mm) and the Automated Planet Finder (APF, d=370 mm, R=1200 mm), at Lick Observatory.

While the UH 2.2 m ASM has as a baseline, a more conventionally slumped shell and a larger fixture allows creation of a backup shell as needed.

Another application is the fabrication of a shell for the Keck ASM project. A larger kiln can be used to create larger shells having a 1400 mm in diameter. An intermediate size shell could be fabricated for validating this approach as the diameter increases.

A variation of the application is to setup a top weight on the sheet of glass that is more complex than a ring. The top weight could, for example, be a series of concentric rings or similar setup that applies the right force as a function of distance from the center to create the desired final curve in the glass sheet.

Process Steps

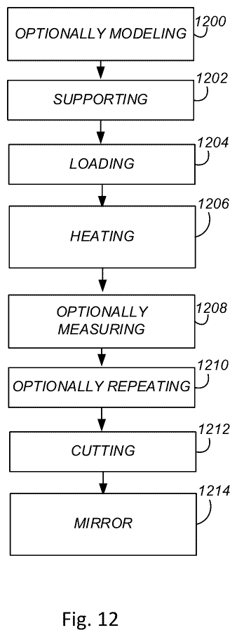

FIG. 12 is a flowchart illustrating a method for forming a sheet of glass into a mirror. The method comprises the following steps.

Block 1200 represents optionally modeling, or obtaining a model for, a desired curvature of the curved mirror surface as a function of the load distribution and the slumping temperature, to obtain a modeled load distribution and a modeled slumping temperature; wherein the loading comprises loading with the modeled load distribution and the slumping temperature comprises the modeled slumping temperature.

Block 1202 represents supporting a flat or planar glass sheet with a support structure only in a first region on an underside of the glass sheet.

Block 1204 represents loading the glass sheet with a load distribution (e.g., line load, or perimeter load) using a load structure and only in a second region on a top side of the glass sheet.

Block 1206 represents heating the glass sheet, supported between the load structure and the support structure, to a slumping temperature so as to form a curved mirrored surface of the glass sheet when the first region and second region are the only contact regions with the glass sheet other than with an atmosphere through an opening in the load structure.

In one or more examples, the slumping temperature is a transformation temperature that softens the glass sheet so as to allow the glass in the glass sheet to flow under the force of gravity and the pressure applied by the loading. In one or more examples, the slumping temperature is in a range of 500° C.-1100° C. and the load distribution comprises a mass in a range of 1-15 kg distributed along a perimeter of the mirror's aperture.

Block 1208 represents optionally measuring at least one of a surface roughness or a curvature of the curved mirrored surface.

Block 1210 represents optionally comparing the surface roughness with a target surface roughness to obtain a roughness error and/or comparing the curvature with a target curvature to obtain a curvature error; and repeating the steps of Blocks 1202-1206 using the load distribution comprising a modified load distribution determined using the roughness error and the slumping temperature comprising a modified slumping temperature determined using the curvature error.

Block 1212 represents optionally cutting the glass sheet along an inside of the second region to form the mirror comprising the aperture.

Block 1214 represents the end result, a mirror. The mirror can be embodied in many ways including, but not limited to, the following examples.

1. A mirror 436, comprising:
a glass sheet 406 having a mirrored surface 422, the mirrored surface comprising a curvature and finish or surface roughness formed by slumping from a restraint 401 in a first region 408 while under load 416 in a second region 418, when the restraint 401 and the load 416 are the only contacts with the glass sheet 406 other than an atmosphere 424.

2. The mirror of example 1, wherein the mirrored surface 422 comprises an aperture 426 bounded by positioning of the load 416 along a perimeter P of the aperture 426.

3. The mirror of any of the examples 1-2, wherein the first region 408 comprises a first annular region having a first radius and the second region 418 comprises a second annular region having a second radius smaller than the first radius.

4. The mirror of example 3, wherein the mirror has a radius D/2 bounded by the first annular region 408.

5. The mirror of any of the examples 1-4, wherein the curvature and finish are defined by elastic deformation of the glass sheet as a result of the slumping.

6. The mirror of any of the examples 1-5, wherein the curvature and finish are approximated by Roarke' formulas.

7. The mirror of any of the examples 1-6, wherein:
the mirror comprises a telescope mirror having the finish (or specular reflectance) useful for an astronomical observation, or
the mirror comprises a solar concentrator having the finish (or specular reflectance) suitable for concentrating solar electromagnetic radiation onto an energy converting device (e.g., solar cell or photovoltaic device) or energy storage device (e.g., salt, water, glass or other material that heats up in response to the concentrated solar radiation), or
the mirror is used in an imaging system and the finish (or specular reflectance) is suitable for forming an image.

8. The mirror of any of the examples 1-7, wherein the curvature comprises a parabola.

9. The mirror of any of the examples 1-8, wherein the mirrored surface has comprises the aperture having a diameter D in a range of 100 millimeters to 1400 mm.

Advantages and Improvements

The present disclosure describes an economical and iterative process for hot forming of curved thin glass facesheets for large format deformable mirrors. To date, the process has been demonstrated for final diameters of up to 120 mm. This process is promising for fabrication of larger facesheets. The iterative nature of the fabrication allows for variation in the setup environment, easing the precision and control requirements of the facility. The technique has a variety of applications, including but not limited to, the fabrication of ASM's or optics integrated with adaptive primaries. The technique further allows for more flexibility in building i deformable mirrors into optics with power at the instrument level.

### REFERENCES

The following references are incorporated by reference herein.
[1] Riccardi, A., Xompero, M., Briguglio, R., Quirós-Pacheco, F., Busoni, L., Fini, L., Puglisi, A., Esposito, S., Arcidiacono, C., Pinna, E., Ranfagni, P., Salinari, P., Brusa, G., Demers, R., Biasi, R., and Gallieni, D., “The adaptive secondary mirror for the Large Binocular Telescope: optical acceptance test and preliminary on-sky commissioning results,” in [Adaptive Optics Systems II], Ellerbroek, B. L., Hart, M., Hubin, N., and Wizinowich, P. L., eds., Society of Photo-Optical Instrumentation Engineers (SPIE) Conference Series 7736, 77362C (July 2010).
[2] Biasi, R., Gallieni, D., Salinari, P., Riccardi, A., and Mantegazza, P., “Contactless thin adaptive mirror technology: past, present, and future,” in [Adaptive Optics Systems II], Ellerbroek, B. L., Hart, M., Hubin, N., and Wizinowich, P. L., eds., Society of Photo-Optical Instrumentation Engineers (SPIE) Conference Series 7736, 77362 B (July 2010).
[3] Kuiper, S., Doelman, N., Human, J., Saathof, R., Klop, W., and Maniscalco, M., “Advances of TNO's electromagnetic deformable mirror development,” in [Advances in Optical and Mechanical Technologies for Telescopes and Instrumentation III], Navarro, R. and Geyl, R., eds., Society of Photo-Optical Instrumentation Engineers (SPIE) Conference Series 10706, 1070619 (July 2018).
[4] Young, W. C., Budynas, R. G., and Sadegh, A. M., [Roark's formulas for stress and strain; 8th ed.], McGraw Hill, New York, NY (2012).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for forming a sheet of glass, comprising:
a support structure comprising a first opening bounded by a first mounting frame dimensioned for supporting the glass sheet in a first region on an underside of the glass sheet, and
a load structure comprising a second opening bounded by a second mounting frame dimensioned for loading a glass sheet with a load distribution in a second region on a top surface of the glass sheet; so that:
slumping of the glass sheet at a slumping temperature forms a mirrored surface on the top surface when the first region and second region are the only contact regions with the glass sheet,
the mirrored surface is formed during exposure to an atmosphere through the second opening,
the mirrored surface comprises an aperture bounded by the second region, and
the first region is outside the second region.

2. The apparatus of claim 1, wherein the first mounting frame comprises a first ring or annulus and the second mounting frame comprises a second ring or annulus having a diameter smaller than the first ring or annulus.

3. The apparatus of claim 2, wherein the first ring and the second ring are mounted on the glass sheet concentrically.

4. The apparatus of claim 1, further comprising:
a kiln comprising a chamber; wherein the kiln is configured to heat the glass sheet, supported between the load structure and the support structure, to the slumping temperature.

5. The apparatus of claim 4, further comprising a computer or controller controlling the slumping temperature so as to form the mirrored surface.

6. A mirror, comprising:
a glass sheet having a mirrored surface, the mirrored surface comprising a curvature and finish or surface roughness formed by slumping from a restraint in a first region while under load in a second region, when the restraint and the load are the only contacts with the glass sheet other than an atmosphere.

7. The mirror of claim 1, wherein the mirrored surface comprises an aperture bounded by positioning of the load along a perimeter of the aperture.

8. The mirror of claim 6, wherein the first region comprises a first annular region having a first radius and the second region comprises a second annular region having a second radius smaller than the first radius.

9. The mirror of claim 8, wherein the mirror has a radius bounded by the first annular region.

10. The mirror of claim 6, wherein the curvature and finish are defined by elastic deformation of the glass sheet as a result of the slumping and can be approximated by Roarke's formulas.

11. The mirror of claim 6, wherein:
the mirror comprises a telescope mirror having the finish (or specular reflectance) useful for an astronomical observation, or
the mirror comprises a solar concentrator having the finish (or specular reflectance) suitable for concentrating solar electromagnetic radiation onto an energy converting device (e.g., solar cell or photovoltaic device) or energy storage device (e.g., salt, water, glass or other material that heats up in response to the concentrated solar radiation), or
the mirror is used in an imaging system and the finish (or specular reflectance) is suitable for forming an image.

12. The mirror of claim 6, wherein the curvature comprises a parabola.

13. The mirror of claim 6, wherein the mirrored surface comprises the aperture having a diameter in a range of 100 millimeters to 1400 mm.

14. A method for forming a sheet of glass into a mirror, comprising:
(a) supporting a flat or planar glass sheet with a support structure only in a first region on an underside of the glass sheet;
(b) loading the glass sheet with a load distribution using a load structure and only in a second region on a top side of the glass sheet;
(c) heating the glass sheet, supported between the load structure and the support structure, to a slumping temperature so as to form a curved mirrored surface of the glass sheet when the first region and second region are the only contact regions with the glass sheet other than with an atmosphere through an opening in the load structure.

15. The method of claim 14, further comprising:
modeling a desired curvature of the curved mirror surface as a function of the load distribution and the slumping temperature, to obtain a modeled load distribution and a modeled slumping temperature; wherein the loading comprises loading with the modeled load distribution and the slumping temperature comprises the modeled slumping temperature.

16. The method of claim 14, wherein the method comprises an iterative process, comprising:
measuring at least one of a surface roughness or a curvature of the curved mirrored surface;
comparing the surface roughness with a target surface roughness to obtain a roughness error and/or comparing the curvature with a target curvature to obtain a curvature error;
repeating steps (a)-(c) using the load distribution comprising a modified load distribution determined using the roughness error and the slumping temperature comprising a modified slumping temperature determined using the curvature error.

17. The method of claim 14, wherein the mirrored surface comprises an aperture bounded by the second region along a perimeter of the aperture, the method further comprising cutting the glass sheet along an inside of the second region to form the mirror comprising the aperture.

18. The method of claim 14, wherein the support structure comprises a first ring contacting the glass sheet in the first region comprising a first annular region having a first radius and the load structure comprises a second ring contacting the glass sheet in the second region comprising a second annular region having a second radius smaller than the first radius.

19. The method of claim 14, wherein the slumping temperature is a transformation temperature that softens the glass sheet so as to allow the glass in the glass sheet to flow under the force of gravity and the pressure applied by the loading.

20. The method of claim 14, wherein the slumping temperature is in a range of 500° C.-1100° C. and the load distribution comprises a mass in a range of 1-15 kg distributed along a perimeter of the mirror's aperture.
